(19) United States
(12) Patent Application Publication
(10) Pub. No.: US 2009/0120251 A1
(43) Pub. Date: May 14, 2009

(54) Machining method and apparatus for brittle material

(75) Inventors: Min-Wei Hung, Sinjhuang City (TW); Wen-Hong Wu, Kaohsiung City (TW); Kuo-Cheng Huang, Hsinchu City (TW); Chi Hung Huang, Hsinchu City (TW)

Correspondence Address: Haverstock & Owens LLP, 162 North Wolfe Road, Sunnyvale, CA, 94086, US

(73) Assignee: National Applied Research Laboratories

(21) Appl. No.: 12/151,187

(22) Filed: May 2, 2008

(30) Foreign Application Priority Data
Nov. 9, 2007 (TW) 96133936

(51) Int. Cl. B26D 7/00; B26D 1/00

(52) U.S. Cl. 83/13; 83/169

(57) ABSTRACT

A machining method for a brittle material is provided. The machining method includes steps of heating the brittle material; providing a concentrated cold source; and spurting the concentrated cold source on a surface of the brittle material along a predetermined cutting path.

### FIELD OF THE INVENTION

The present invention relates to a machining method and apparatus, and more particularly to a machining method and apparatus for brittle material.

### BACKGROUND OF THE INVENTION

There are three major techniques for cutting the brittle material. These three techniques include cutting soft material by using hard material, thermal fusion, and thermal fracture. For the technique of cutting soft material by using hard material, the cutting tools are made of the materials with higher hardness, such as diamond, emery, etc., than the material to be cut. However, not only are the powders and chips easily generated during the cutting process, but also the cutting surfaces are very rough. Therefore, additional surface treatment is required to reduce the roughness on the edges. Besides, the thickness of the material to be cut is quite limited by using this technique.

For the technique of thermal fusion, the light beam with the high energy power is used as the heat source. This light beam is focused on the surface of the brittle material to generate heat in a short time. When enough heat is accumulated, the surface area exposed to this light beam may be fused or sublimated, so the cutting purpose can be achieved. For example, in the Taiwan Patent No. I277477, the laser beam is used as the heat source to cut the brittle material. The required energy power is quite high by using this thermal fusion technique. The fused material may squirt and deface the surface of the material near the cutting line. In addition, the fused material may solidify again and accumulate.

In the thermal fracture technique, the laser is applied as a heat source to generate a specific temperature field. The thermal fracture occurs, where the required hot field and cold filed intersect. The laser beam is focused on the surface of the glass substrate by the optical lens to create the hot field, and the appropriate cooling is applied simultaneously to generate an initial crack on the edge of the substrate. When the temperature difference is generated around the initial crack and the enough stress intensity factor field is created by the hot field and cold field, the fracture may grow to the other end to accomplish the cutting outcome.

The laser thermal fracture technique has several advantages, such as fast processing speed, small thermal area, smooth cutting surfaces, low remnant thermal stress, etc. So the laser thermal fracture technique has been gradually replacing the traditional diamond cutting technique. However, both laser thermal fusion and laser thermal fracture techniques are using the lasers as the heat sources. The frequently used lasers are CO₂ laser and YAG laser, and the light beams of both are invisible and high-powered. The careless exposure to this light beam may incur burning, and the incidence of this light beam into eyes may result in blindness, so it is dangerous during the operation. Besides, the laser machine is expensive and the maintenance cost thereof is high as well.

In order to provide a better solution, the inventors of the present invention develop the “machining method and apparatus for brittle material”, where the cold source is applied to the hot filed to create the necessary hot and cold fields for the fracture growth. The diamond cutting wheels and expensive laser are not required any more, and all the disadvantages of the current techniques can be eliminated. The present invention is described below.

### SUMMARY OF THE INVENTION

In accordance with one aspect of the present invention, a machining method and apparatus for brittle material is provided. The present invention has a lower cost than the prior art, and is able to eliminate the various drawbacks of the prior art, such as rough cutting surfaces, defacing the surface due to the squirting of the fused material, the safety issue during the operation, etc.

In accordance with another aspect of the present invention, a machining method for a brittle material is provided. The machining method includes steps of heating the brittle material, providing a concentrated cold source, and spurting the concentrated cold source on a surface of the brittle material along a predetermined cutting path.

Preferably, the machining method further includes a step of generating a notch on an edge of the brittle material as a starting point of the predetermined cutting path.

Preferably, the brittle material is fixed and the concentrated cold source is moving along the predetermined cutting path.

Preferably, the concentrated cold source is fixed and the brittle material is moving along the predetermined cutting path.

Preferably, both the brittle material and the concentrated cold source are movable.

Preferably, the step of heating the brittle material raises a temperature of the brittle material up to 70° C. to 120° C.

Preferably, a temperature of the concentrated cold source is between −20° C. to 5° C.

In accordance with a further aspect of the present invention, a machining apparatus for a brittle material is provided. This machining apparatus includes a base containing a carrier to carry the brittle material, a heating device connected to the base for heating the brittle material, a concentrated cold source providing device configured opposite to the carrier to provide a concentrated cold source, and a moving device mounted on the base to change a relative position between the brittle material and the concentrated cold source providing device.

Preferably, the machining apparatus further includes a loading device connected to the heating device and the carrier to deliver the brittle material to the carrier after heated.

Preferably, the brittle material is made of at least one selected from a group consisting of a glass, a silica and a ceramic.

Preferably, the brittle material has a shape of a plate.

Preferably, the concentrated cold source is a fluid being at least one selected from a group consisting of a high-pressure air, a water, a nitrogen, and a carbon dioxide.

Preferably, the concentrated cold source includes at least one cold source.

In accordance with further another aspect of the present invention, a machining apparatus for a brittle material is provided. The machining apparatus includes a carrier carrying the brittle material, a heating device heating the brittle material, and a movable concentrated cold source providing device providing a concentrated cold source to be spurted on a surface of the heated brittle material along a predetermined cutting path.

Preferably, the heating device is connected to the carrier.

Preferably, the movable concentrated cold source providing device is mounted opposite to the carrier.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing the machining method for brittle material according to a preferred embodiment of the present invention; and

FIG. 2 is a schematic diagram showing the machining apparatus for brittle material according to a preferred embodiment of the present invention.

### DETAILED DESCRIPTION OF THE PREFERRED EMBODIMENT

The present invention will now be described more specifically with reference to the following embodiments. It is to be noted that the following descriptions of this invention are presented herein for the purposes of illustration and description only; it is not intended to be exhaustive or to be limited to the precise form disclosed.

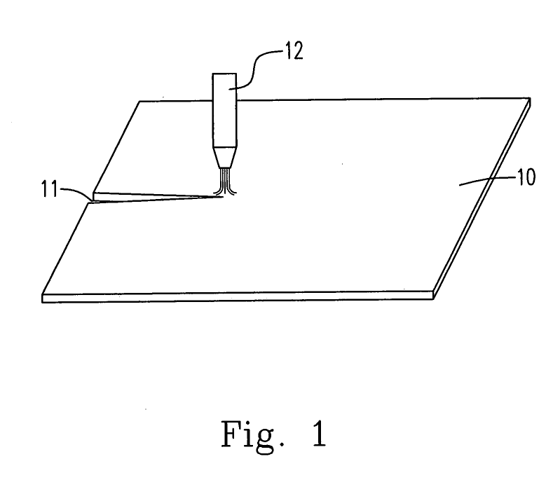

Please refer to FIG. 1, which is a schematic diagram showing the machining method for brittle material according to a preferred embodiment of the present invention. The present invention discards the method of heating and cooling in partial areas in the traditional thermal fusion and thermal fracture techniques. The concentrated cold source 12 is applied under the hot field to form the required hot and cold fields for the growth of the fracture 11 in the present invention. At first, the brittle material 10 is uniformly heated up to about 100° C. to generate a uniform hot field. If the edge of the brittle material 10 is quite smooth, it may be required to make an initial notch on the edge; however, it is not required to do so, if the edge is rough. Then the concentrated cold source 12 is applied to the tip of the fracture 11 to generate the required hot and cold fields in the local area in order to facilitate the growth of the fracture 11. The concentrated cold source 12 can move along the desired cutting path, and then the brittle material 10 can be cut in the desired shape. Since the uniform hot field is provided for the brittle material 10, the present method can be applied to any brittle material 10, which is not seriously affected by heating, such as glass, silica, and ceramic.

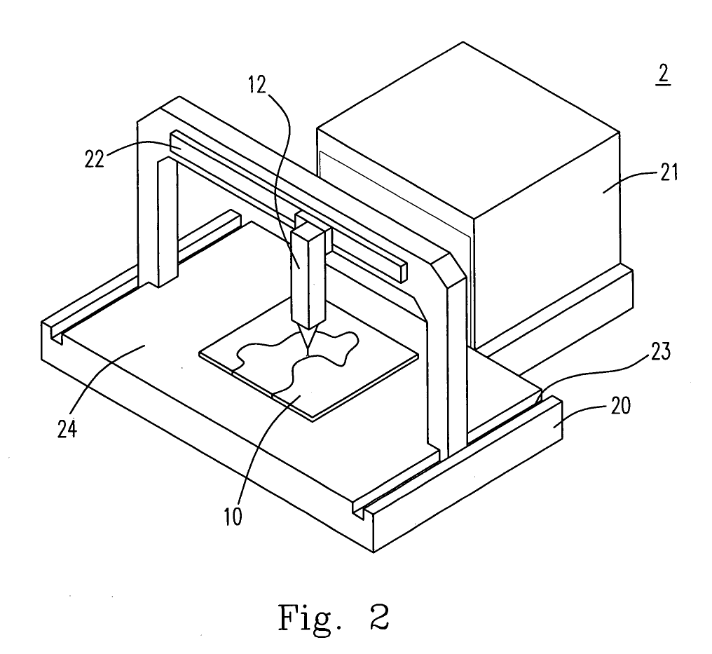

Please refer to FIG. 2, which is a schematic diagram showing the machining apparatus for brittle material according to a preferred embodiment of the present invention. The main body of the present embodiment is a base 20, which can be designed to be placed on the ground or on the working bench. The base 20 includes a carrier 24 to carry the brittle material 10. Generally, the brittle material 10 has a shape of a plate, so the carrier 24 is planar, and can be designed in various shapes according to the actual requirement. The present embodiment further includes the heater 21 located on the base 20 to heat the brittle material 10 up to about 70 to 120° C. The heater 21 may be the resistive oven, the quartz tube oven or other heating tools. For successfully transporting the brittle material 10 to the carrier 24 after heating, the machining apparatus 2 further includes a loading device connected between the heater 21 and the carrier 24 (not shown).

Please refer to FIG. 2 again. In the present embodiment, the fluid can be spurted from the tiny spout of the concentrated cold source 12 to generate a local cold field in the brittle material 10. There is only one spout in the concentrated cold source 12 in the present embodiment. The spout quantity and the spurt strength can be adjusted according to the actual requirement. The thickness of various brittle materials 10 can be taken into account for this adjustment. The fluid of the concentrated cold source 12 can be high-pressure air, water, nitrogen, carbon dioxide, or others. The cold field with the temperature from −20 to 5° C. can be provided, based on the different cold source. In the present embodiment, the brittle material 10 is fixed, and the moving path of the concentrated cold source 12 is controlled by the X-axis moving element 22 and Y-axis element 23 in order to finish the cutting in the desired shape. Alternatively, the concentrated cold source 12 of the machining apparatus 2 in the present invention can be fixed, while the brittle material 10 can be disposed on the moving elements to execute the cutting process.

The fracture growth is influenced more by the cold field than by the hot field. As long as the appropriate stress intensity factor field or the appropriate hot and cold fields are created, the fracture of the brittle material occurs. In the present invention, the hot and cold temperatures are relative. If the temperature of the provided hot source is quite high, then it is not necessary to reduce the temperature of the cold source to very low to generate the fracture. On the other hand, if the temperature of the provided hot source is not high, then the temperature of the cold source must be relatively low enough to generate the fracture.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A machining method for a brittle material, comprising steps of:
heating the brittle material;
providing a concentrated cold source; and
spurting the concentrated cold source on a surface of the brittle material along a predetermined cutting path.

2. A machining method for a brittle material as claimed in claim 1, further comprising a step of generating a notch on an edge of the brittle material as a starting point of the predetermined cutting path.

3. A machining method for a brittle material as claimed in claim 1, wherein the brittle material is fixed and the concentrated cold source is moving along the predetermined cutting path.

4. A machining method for a brittle material as claimed in claim 1, wherein the concentrated cold source is fixed and the brittle material is moving along the predetermined cutting path.

5. A machining method for a brittle material as claimed in claim 1, wherein both the brittle material and the concentrated cold source are movable.

6. A machining method for a brittle material as claimed in claim 1, wherein the brittle material is made of at least one selected from a group consisting of a glass, a silica and a ceramic.

7. A machining method for a brittle material as claimed in claim 1, wherein the brittle material has a shape of a plate.

8. A machining method for a brittle material as claimed in claim 1, wherein the step of heating the brittle material raises a temperature of the brittle material up to 70° C. to 120° C.

9. A machining method for a brittle material as claimed in claim 1, wherein a temperature of the concentrated cold source is between −20° C. to 5° C.

10. A machining method for a brittle material as claimed in claim 1, wherein the concentrated cold source is a fluid.

11. A machining method for a brittle material as claimed in claim 10, wherein the fluid is at least one selected from a group consisting of a high-pressure air, a water, a nitrogen, and a carbon dioxide.

12. A machining method for a brittle material as claimed in claim 1, wherein the concentrated cold source comprises at least one cold source.

13. A machining apparatus for a brittle material, comprising:
a base comprising a carrier to carry the brittle material;
a heating device connected to the base for heating the brittle material;
a concentrated cold source providing device configured opposite to the carrier to provide a concentrated cold source; and
a moving device mounted on the base to change a relative position between the brittle material and the concentrated cold source providing device.

14. A machining apparatus for a brittle material as claimed in claim 13, wherein the brittle material is made of at least one selected from a group consisting of a glass, a silica and a ceramic.

15. A machining apparatus for a brittle material as claimed in claim 13, wherein the brittle material has a shape of a plate.

16. A machining apparatus for a brittle material as claimed in claim 13, wherein the concentrated cold source is a fluid being at least one selected from a group consisting of a high-pressure air, a water, a nitrogen, and a carbon dioxide.

17. A machining apparatus for a brittle material as claimed in claim 13, wherein the concentrated cold source comprises at least one cold source.

18. A machining apparatus for a brittle material, comprising:
a carrier carrying the brittle material;
a heating device heating the brittle material; and
a movable concentrated cold source providing device providing a concentrated cold source to be spurted on a surface of the heated brittle material along a predetermined cutting path.

19. A machining apparatus for a brittle material as claimed in claim 18, wherein the heating device is connected to the carrier.

20. A machining apparatus for a brittle material as claimed in claim 18, wherein the movable concentrated cold source providing device is mounted opposite to the carrier.
